(19) United States
(12) Patent Application Publication
(10) Pub. No.: US 2024/0124738 A1
(43) Pub. Date: Apr. 18, 2024

(54) ADDITIVE MANUFACTURING PROCESS BY EXTRUSION OF A POLY-ETHER-KETONE-KETONE BASED COMPOSITION

(71) Applicant: ARKEMA FRANCE, Colombes (FR)

(72) Inventors: Roderick REBER, King of Prussia, PA (US); Guillaume LE, Serquigny (FR)

(73) Assignee: ARKEMA FRANCE, COLOMBES (FR)

(21) Appl. No.: 18/270,257

(22) PCT Filed: Dec. 23, 2021
(86) PCT No.: PCT/EP2021/087617

§ 371 Date: Jun. 29, 2023

Related U.S. Application Data
(60) Provisional application No. 63/131,822, filed on Dec. 30, 2020.

(51) Int. Cl. C09D 161/16; B33Y 70/00; C08G 65/40; C09D 11/102

(52) U.S. Cl. CPC C09D 161/16; B33Y 70/00; C08G 65/4012; C09D 11/102; B29K 2071/00; C08G 2650/48

(57) ABSTRACT

The invention concerns an additive manufacturing process by extrusion for forming a three-dimensional part with an additive manufacturing machine comprising a nozzle, the process comprising:
i) providing a pseudo-amorphous composition having a glass temperature Tg;
ii) softening the composition at a softening temperature above Tg and below 300° C. to form a softened composition which is fluid enough to flow and, extruding the softened composition from the nozzle to form an extruded part section; and,
iii) solidifying the extruded part section;
wherein the composition is based on a homopolymer or a copolymer of poly-ether-ketone-ketone, consisting of: at least an isophthalic (I) repeating unit, having the formula:

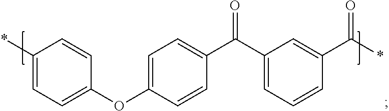

and, in the case of the copolymer, a terephthalic (T) repeating unit, having the formula:

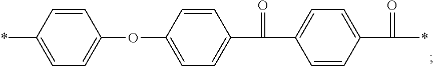

wherein the molar proportion of T units relative to the sum of the T and I units ranges from 0% to 45% or from 55% to 65%.

### TECHNICAL FIELD

The present invention relates to extrusion additive manufacturing processes, including fused filament fabrication, which may be used to manufacture improved parts, devices, and prototypes using a composition comprising one or more poly-aryl-ether-ketones.

### TECHNICAL BACKGROUND

Material extrusion additive manufacturing are processes that may be used to manufacture devices, parts, and prototypes. Material extrusion additive manufacturing includes fused filament fabrication (“FFF”) in which the material is under the form of a filament.

Fused Filament Fabrication is a widely adopted additive manufacturing technique. Part of the appeal of Fused Filament Fabrication is its relative simplicity in implementation. A basic printer requires only a few electrical motors and a heated print head. A wide range of Fused Filament Fabrication or other extrusion printers are currently commercially available ranging from consumer models that only cost a few hundred dollars to sophisticated industrial machines capable of consistently producing large objects from advanced materials with high levels of reliability and repeatability. As with any piece of mechanical equipment, increasing complexity and robustness is usually accompanied with increased cost and maintenance. For some purposes, it may be needed to make objects from high performance polymers such as PAEKs without the use of expensive and complex equipment capable of reaching high temperatures.

For many applications, it is desirable to create objects using Fused Filament Fabrication, out of high performance thermoplastic polymers such as poly-aryl-ether-ketones. Generally speaking, these materials are preferred because of some combination of strength, toughness, heat resistance, chemical resistance, low flammability, or other desirable physical property.

However, as explained below, the use of semi-crystalline or crystallizable compositions of PAEK in fused filament fabrication, such as PEEK which is the PAEK which has been most extensively studied, faces several challenges. PEEK polymer is known to have a glass transition temperature of around 143° C. and a melting temperature of around 343° C.

Most of studies have indicated that PEEK has to be extruded at a temperature above or well above its melting point, with a nozzle temperature between generally 350° C. and 480° C. Indeed, it has been shown that a high temperature may be beneficial to avoid nozzle clogging and delamination of deposited layers. On the other hand, the higher the temperature is, the more the polymer is exposed to thermal degradation phenomena.

In addition, since materials typically contract when cooled, the build environment temperature in which a part is printed is generally maintained at a temperature above the T_{g} to avoid residual stress to accumulate. However, as PEEK has a rather fast crystallization kinetics when cooled down from the extrusion temperature to the build environment temperature, it may crystallize. The crystallization is very difficult to control and the printed part may result in being unhomogeneously crystallized. This may lead to warpage, dimensional inaccuracy, porosity, and/or unhomogeneous mechanical properties.

The present invention is directed to an additive manufacturing process by extrusion to form three-dimensional parts using a composition comprising poly-ether-ketone-ketone(s), which may be carried out at a lower extrusion temperature and/or in which warpage and/or crystallization inhomogeneities are avoided.

The present invention is also directed to a filament and its use in an additive manufacturing process by extrusion and the objects produced using the process according to the invention.

### SUMMARY

The invention concerns an additive manufacturing process by extrusion for forming a three-dimensional part with an additive manufacturing machine comprising a nozzle. The process comprises:
i) providing a pseudo-amorphous composition having a glass temperature Tg;
ii) softening the composition at a softening temperature above Tg and below 300° C. to form a softened composition which is fluid enough to flow and, extruding the softened composition from the nozzle to form an extruded part section; and,
iii) solidifying the extruded part section.

The composition used in the process is based on a homopolymer or a copolymer of poly-ether-ketone-ketone, essentially consisting of, preferably consisting of: at least an isophthalic (I) repeating unit, having the formula:

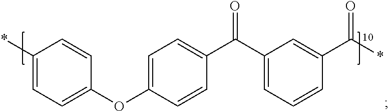

and, in the case of the copolymer, a terephthalic (T) repeating unit, having the formula:

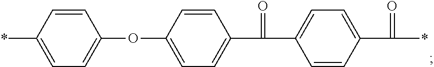

wherein the molar proportion of T units relative to the sum of the T and I units ranges from 0% to 45% or from 55% to 65%.

In some embodiments, the molar proportion of T units relative to the sum of the T and I units of the poly-ether-ketone-ketone of the composition may be equal to or less than 15%, or equal to or less than 10%, or equal to or less than 5%, or equal to or less than 2%, or equal to or less than 1%.

In some embodiments, the poly-ether-ketone-ketone of the composition may consist essentially of, or consist of the isophthalic (I) repeating unit.

In some embodiments, the composition may have an inherent viscosity, as measured according to ISO 307 in an aqueous solution of 96% by weight sulfuric acid at 25° C., from about 0.10 dL/g to about 0.90 dL/g, preferably from about 0.15 dL/g to about 0.85 dL/g, and more preferably from about 0.30 dL/g to about 0.80 dL/g.

In some embodiments, the poly-ether-ketone-ketone of the composition may be obtainable by the reaction of 1,3-bis(4-phenoxybenzoyl)benzene and/or 1,4-bis(4-phenoxybenzoyl)benzene with isophthaloyl chloride and/or terephthaloyl chloride. In some embodiments, the composition may have a viscosity at the softening temperature in the range of 200 to 5000 Pa·s⁻¹ during a time range of more than 30 seconds, preferably more than 2 minutes, and more preferably during a time range of more than 5 minutes, as measured in a plate-plate rheometer device at a stress frequency of around or less than 5 rad/s.

In some embodiments, the initial viscosity at the softening temperature may be greater than 200 Pa·s⁻¹, or greater than 600 Pa·s⁻¹, or greater than 1000 Pa·s⁻¹, or greater than 1500 Pa·s⁻¹.

In some embodiments, the softening temperature is less than Tm+5° C., preferably is less than or equal to Tm, and more preferably is: less than or equal to Tm−5° C., or less than or equal to Tm−10° C., or less than or equal to Tm−20° C., or less than or equal to Tm−30° C.; and/or
the softening temperature is greater than Tg+50° C., and preferably greater than or equal to Tg+75° C.

The invention also concerns a filament made of the composition used in the process of the invention.

The invention also concerns the use of the composition in an additive manufacturing process by extrusion.

The invention finally concerns an object obtained by the process of the invention.

### FIGURES

FIG. 1 represents the viscosity, expressed in Pa·s, in function of time, expressed in seconds at a temperature of 250° C., using an ARES-G2 rheometer with 25 mm parallel plates in a nitrogen atmosphere.

FIG. 2 represents the viscosity, expressed in Pa·s, in function of time, expressed in seconds at a temperature of 260° C., using an ARES-G2 rheometer with 25 mm parallel plates in a nitrogen atmosphere.

### DESCRIPTION OF EMBODIMENTS

The invention will now be described in more detail without limitation in the following description.

As used herein, the term “glass transition temperature”, also referred to herein as “Tg”, means the temperature over which a glass transition takes place, that is amorphous regions of a polymer go from a hard and relatively brittle condition to a viscous or rubbery condition, or vice-versa. It can be measured by Differential Scanning Calorimetry according to ISO 11357-2: 2013, by using a heating rate of 20° C./min as measured on the second heating cycle. Unless otherwise indicated, the glass transition temperature is a half-step height glass transition temperature. Compositions may optionally have several glass transition temperatures measured by DSC analysis. In that case, the term “glass transition temperature” means the highest glass transition temperature of the composition.

As used herein, “pseudo-amorphous” polymers comprise polymers having from 0% crystallinity to less than about 7% crystallinity as determined by X-ray diffraction (XRD). For instance, X-ray diffraction data may be collected with copper K-alpha radiation at 0.5 deg/min for two-theta angles ranging from 5.0° to 60.0°. The step size used for data collection should be 0.05° or lower. The diffractometer optics should be set as to reduce air scattering in the low angle region around 5.0° two-theta. Crystallinity data may be calculated by peak fitting X-ray patterns and taking into account crystallographic data for the polymer of interest. A linear baseline may be applied to the data between 5° and 60°. For example, pseudo-amorphous polymers as discussed herein may be below about 7% crystallinity, preferably below about 5% crystallinity, more preferably below about 3% crystallinity and most preferably below 1% or about 0%.

As used herein, “semi-crystalline” polymers comprise polymers having at least about 3% crystallinity as determined by X-ray diffraction. Semi-crystalline polymers as discussed herein may comprise at least about 5% crystallinity or at least about 7% crystallinity, with a preference of at least about 5% crystallinity. Pseudo-amorphous polymers may be crystallizable, that is capable of forming one or more regions that are crystalline upon a heat treatment above their glass transition temperature.

As used herein, the term “melt temperature”, also referred to herein as “Tm”, means the temperature over which a transition stage between a fully crystalline or partially crystalline solid state and an amorphous liquid of variable viscosity occurs. Generally it may be measured by Differential Scanning Calorimetry (DSC), according to ISO 11357-3:2018, by locating the peak of melt temperature of the second heat using a heating rate of 20° C./min. However for the pseudo-amorphous polymers used in the invention, it may be necessary to modify the standard method as no peak can generally be observed. In case no peak is observed, which is generally the case, the peak of melt may be located on first heat by: firstly heating the composition to a temperature several tens of degrees above its Tg, for example at a temperature of: (Tg+90) ° C., for several dozens of minutes, for example for 120 minutes, and secondly heating the composition with a ramp of 20° C./min. Since these materials are so slow to crystalize this extra step is needed so that crystals can be formed in order to measure their melting temperature.

Unless otherwise indicated, the melt temperature is a peak melt temperature. The composition may optionally have several melt temperatures measured by DSC analysis, for instance due to the presence of different crystalline forms for a given polymer. In that case, the term “melt temperature” means the highest melt temperature of the composition.

As used herein, the term “homopolymer” means a polymer consisting essentially of, preferably consisting of, a single repeating unit.

As used herein, the term “copolymer” means a polymer comprising at least two different repeating units. The polymer may consist essentially of, or consist of, two different repeating units.

As used herein, the term “essentially consisting of repeating unit(s)” means that the repeating unit(s) represent(s) a molar proportion of at least 98.5% in the polymer. The term “consisting of unit(s)” means that the unit(s) represent(s) a molar proportion of at least 99.9%, ideally 100% when end chains are disregarded, in the polymer.

As used herein, the term “inherent viscosity” means the viscosity as measured in in an aqueous solution of 96% by weight of sulfuric acid at 25° C., according to ISO 307. The inherent viscosity is expressed in dL/g.

As used herein, the terms “at least one” and “one or more of” an element are used interchangeably, and have the same meaning that includes a single element and a plurality of the elements, and may also be represented by the suffix “(s)” at the end of the element.

As used herein, the term “a”, respectively “the”, generally means “at least one”, respectively “the at least one”.

As used herein, the terms “comprising” and “including” are inclusive or open-ended and do not exclude additional unrecited elements, compositional components, or method steps. Accordingly, the terms “comprising” and “including” encompass the more restrictive terms “consisting essentially of” and “consisting of.”

As used herein, each compound may be discussed interchangeably with respect to its chemical formula, chemical name, abbreviation, etc. For example, PEKK may be used interchangeably with poly-ether-ketone-ketone or its chemical formula.

As used herein, the “Z-axis” corresponds to the layer-printing direction of a 3D part. On the contrary, “X-axis” and “Y-axis” correspond to the plan in which the layers are printed.

### Low Melting Point Poly-Ether-Ketone-Ketone(s) (PEKK(s))

The poly-ether-ketone-ketone of the composition may be a homopolymer essentially consisting of, preferably consisting of an isophthalic repeat unit (“I”), of formula:

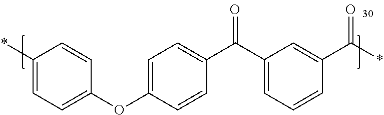

The PEKK may also be a copolymer essentially consisting of, preferably consisting of: an isophthalic repeat unit (“I”) and a terephthalic repeat unit (“T”), of formula:

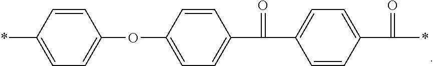

The molar proportion of T units relative to the sum of the T and I units may be in the range from 0% to 45% or from 55% to 65%. In this range of T:I proportions, PEKK has a crystallization kinetics which is particularly suitable for use in an additive manufacturing process by extrusion and a low melting temperature. Indeed, the crystallization kinetics at the softening temperature is slow enough so that nozzle clogging issues can be avoided. In some embodiments, as detailed below, this also enables to soften the pseudo-amorphous composition at a temperature below its melting temperature. In addition, the crystallization kinetics at the build temperature is slow enough so that warpage and crystallization inhomogeneities issues can also be avoided.

The melt temperature of the poly-ether-ketone-ketone is less than or equal to 320° C. Advantageously, the melt temperature of PEKK is less than or equal to 310° C., or less than or equal to 300° C., or less than or equal to 290° C. The melt temperature of the PEKK consisting of isophthalic repeat units has been measured by DSC at 281° C. In some embodiments, the melt temperature of the PEKK may be even less than or equal to 280° C., or less than or equal to 275° C., or less than or equal to 270° C.

Although having a fairly low melting point, the PEKK may have nevertheless a high glass transition temperature, notably a glass transition temperature greater than or equal to 150° C. This is particularly advantageous for considering the use of objects obtained by an additive manufacturing process by extrusion in stringent temperature conditions.

The molar ratio of terephthalic unit to isophthalic and terephthalic units (T:T+I) may be from 0 to 5%; or from 5 to 10%; or from 10 to 15%; or from 15 to 20%; or from 15 to 20%; or from 20 to 25%; or from 25 to 30%; or from 30 to 35%; or from 35 to 40%; or from 40 to 45%; or from 55 to 60%; or from 60 to 65%. The choice of the molar ratio of T units relative to the sum of T and I units makes it possible to adjust the melt temperature of PEKK and its crystallization rate at a given temperature.

Advantageously, the molar ratio of terephthalic unit to isophthalic and terephthalic units (T:T+I) may be from 0 to 15%. In the aforementioned range, increasing the proportion of terephthalic units makes it possible to further reduce the melting temperature of the composition and to reduce the rate of crystallization.

In some embodiments, the molar proportion of T units relative to the sum of the T and I units may be less than or equal to 15%, or less than or equal to 12.5%, or less than or equal to 10%, or less than or equal to 7.5%, or less than or equal to 5%, or less than or equal to 4%, or less than or equal to 3%, or less than or equal to 2.5%, or less than or equal to 2.0%, or less than or equal to 1.5%, or less than or equal to 1.0%.

In some embodiments, the molar proportion of T units relative to the sum of the T and I units may be greater than or equal to 0%, or greater than or equal to 2.5%, or greater than or equal to 3%, or greater than or equal to 4%, or greater than or equal to 5%, or greater than or equal to 7.5%, or greater than or equal to 10%, or greater than or equal to 12.5%, or greater than or equal to 13.0%, or greater than or equal to 13.5%, or greater than or equal to 14.0%.

In some embodiments, the molar proportion of units T relative to the sum of units T and I may be from 0% to 1%, or from 1% to 2%, or from 2% to 3%, or from 3% to 4%, or from 4% to 5%, or from 5% to 6%, or from 6% to 7%, or from 7% to 8%, or from 8% to 9%, or from 9% to 10%, or from 10% to 11%, or from 11% to 12%, or from 12% to 13%, or from 13% to 14%, or from 14% to 15%.

In some embodiments, the PEKK may have an inherent viscosity, as measured according to ISO 307 in an aqueous solution of 96% by weight sulfuric acid at 25° C., from about 0.10 dL/g to about 0.90 dL/g, preferably from about 0.15 dL/g to about 0.85 dL/g, and more preferably from about 0.30 dL/g to about 0.80 dL/g.

These inherent viscosities are particularly advantageous and make it possible to obtain a good compromise between: i) (sufficiently low viscosity) having good interlayer adhesion and/or softening the polymer at a rather low temperature and ii) (sufficiently high viscosity) good mechanical properties of the obtained object.

The PEKK polymer may be obtained by reacting: 1,3 bis(4-phenoxybenzoyl)benzene, 1,4 bis(4-phenoxybenzoyl)benzene, or their mixture with isophthaloyl chloride, terephthaloyl chloride, or their mixture, in the presence of a catalyst. This route makes it possible in particular to improve the thermal stability and the color stability of PEKK.

The polymerization reaction is preferably carried out in a solvent. The solvent is preferably a non-protic solvent, which may be chosen from the list consisting of: methylene chloride, carbon disulfide, ortho-dichlorobenzene, meta-dichlorobenzene, para-dichlorobenzene, 1,2,4-trichlorobenzene, 1,2,3-trichlorobenzene, ortho-difluorobenzene, 1,2-dichloroethane, 1,1-dichloroethane, 1,1,2,2-tetrachloroethane, tetrachloroethylene, dichloromethane, nitrobenzene, or a mixture thereof. Ortho-dichlorobenzene is particularly preferred.

The polymerization reaction is preferably carried out in the presence of a Lewis acid as a catalyst. The Lewis acid may be chosen from the list consisting of: aluminum trichloride, aluminum tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride. Aluminum trichloride, boron trichloride, aluminum tribromide, titanium tetrachloride, antimony pentachloride, ferric chloride, gallium trichloride and molybdenum pentachloride are preferred. Aluminum trichloride is particularly preferred.

In some embodiments, a Lewis base may also be added to the reaction mixture, as described in document U.S. Pat. No. 4,912,181. This may help to delay the apparition of a massive gel which generally renders more complicated certain steps of the manufacturing process.

In some embodiments, a dispersing agent may also be added to the reaction mixture, as described in document WO2011/004164. This may allow to obtain a polymer in the form of dispersed particles that are more easily handled.

The polymerization may be carried out at a temperature ranging, for example, from 20 to 120° C.

The method for manufacturing PEKK advantageously comprises one or more steps of purification of the polymer, such as the steps of:
mixing the products of the polymerization reaction containing PEKK with a protic solvent so as to provide a suspension of PEKK,
separating the PEKK polymer from the suspension, preferably by filtration, and washing.

The protic solvent used for the PEKK suspension may be, for example, an aqueous solution, methanol, or a mixture of an aqueous solution and methanol.

The PEKK polymer may be recovered from the suspension by filtration. If necessary, the polymer may be washed, preferably with a protic solvent such as methanol, and filtered again, one or more times. Washing may be carried out, for example, by resuspending the polymer in the solvent.

The composition according to the invention is based on the PEKK(s) as described hereinabove.

The weight of PEKK or, if relevant, the sum of the weights of PEKKs, generally represents at least 50% of the total weight of the composition. In some embodiments, the weight of PEKK(s) may represent at least 60%, or at least 70%, or at least 80%, or at least 85%, or at least 90%, or at least 92.5%, or at least 95%, or at least 97.5%, or at least 98%, or at least 98.5%, or at least 99% or at least 99.5% of the total weight of the composition.

In some specific embodiments, the composition consists of the PEKK(s) as described hereinabove.

In some embodiments, the PEKK-based composition may comprise a single PEKK having a given chemical composition, for example only the homopolymer.

Alternatively, the composition may comprise at least two types of different PEKKs having different chemical compositions. In other words, the PEKK composition may include two PEKKs with different T:I ratios. The composition may for example comprise the isophthalic homopolymer and a copolymer having a T:I molar ratio greater than 0% and less than or equal to 15%.

The composition may comprise one or more other polymers, in particular thermoplastics, which are not the PEKK used in the composition according to the invention. This other polymer may be another poly-aryl-ether-ketone having a melting point of less than or equal to 300° C., preferably a melting point of less than or equal to the one of the PEKK in the composition. The other polymer may also be a polymer which does not belong to the poly-aryl-ether-ketone family, such as, for example, a polyetherimide (PEI).

The composition may also comprise additives and/or fillers.

The fillers may in particular be reinforcing fillers, including mineral fillers such as carbon black, carbon or non-carbon nanotubes, crushed or non-crushed fibers (glass, carbon). The PEKK-based composition may comprise less than about 50% by weight of filler, and preferably less than 40% by weight of filler relative to the total weight of composition. The PEKK-based composition may comprise less than 35%, or less than 30%, or less than 25%, or less than 20%, or less than 15% by weight of filler relative to the total weight of the composition.

The additives may in particular be stabilizing agents (light, in particular UV, and heat such as phosphates), optical brighteners, dyes, pigments, energy-absorbing additives (including UV absorbers), viscosity-controlling agents, crystallization rate-controlling agents or a combination of these additives.

The composition may comprise less than 15%, preferably less than 10%, preferably less than 5%, and more preferably less than 1% by weight of additives.

The composition is suitable for being printed in an extrusion style 3D printer, with or without filaments. The composition may be in the form of filaments, rods or pellets, generally formed by extrusion.

As the composition is pseudo-amorphous, it is advantageously in the form of a filament. A pseudo-amorphous filament may be obtained by extruding a melted filament and quenching it so that it remains essentially amorphous.

For fused filament fabrication, the filaments may be of any size diameter, including diameters from about 0.6 to about 3 mm, preferably diameters from about 1.7 to about 2.9 mm, more preferably diameters from about 1.7 mm to about 2.8 mm, as measured with an unweighted caliper.

### Additive Manufacturing Process by Filament Extrusion

A device useful for an additive manufacturing process by material extrusion generally comprises all or some of the following components:
a material in the ready to print form, wherein in the invention the material is the PEKK-based composition and a ready to print form may be a pseudo-amorphous filament; the composition is pseudo-amorphous: it has a glass temperature Tg and a melt temperature Tm;
a device feeding the material to one or more print heads;
one or more print heads: a print head generally comprises a liquefier, in which the material may be softened at a specified softening temperature and a nozzle from which the softened material may be extruded;
a print bed or substrate which may or may not be heated, where the part is being built/printed; and
a build environment surrounding the print bed and the object being printed which may or may not be heated or which may or may not be temperature controlled.

The build environment may either be fully or partially enclosed forming a chamber, or open to the environment.

Generally, the extrusion printing process comprises one or more of the following steps:
providing a pseudo amorphous material in the ready to print form, having a glass transition temperature Tg and a melt temperature Tm;
feeding the material into the 3D printer, the parts of which may or may not be heated to one or more predetermined temperatures;
setting the computer controls of the printer to provide a set volume flow of material, and to space the printed lines at a certain spacing;
feeding the material to a heated print head at an appropriate set speed which may be pre-determined;
softening the material at a softening temperature above Tg and below 300° C. to form a softened composition which is fluid enough to flow, the softened composition staying in the print head for a so-called residence time;
moving the print head into the proper position for depositing a set or predetermined amount of softened composition;
extruding the softened composition from the nozzle to form an extruded part section;
optionally adjusting the temperature of the build environment; and,
solidifying the extruded part section in the build environment.

In some embodiments, the softening temperature may be around Tm or above Tm. The softening temperature may notably less than or equal to Tm+5° C., or equal to Tm.

In some preferred embodiments, the softening temperature may be around Tm or below Tm. The softening temperature may notably be equal to Tm, or less than or equal to Tm−5° C., or less than or equal to Tm−10° C., or less than or equal to Tm-20° C., or less than or equal to Tm−30° C.

The softening temperature is generally greater than or equal to Tg+50° C., and preferably greater than or equal to Tg+75° C.

In some embodiments, notably for the PEKK based composition having PEKK(s) with a T:T+I ratio from 0% to 15%, the softening temperature may be chosen between Tg+50° C. and Tm−5° C., and preferably between Tg+75° C. and Tm−10° C. In some embodiments, notably for PEKK consisting of isophthalic repeat units, the softening temperature may be from 240° C. to at most 300° C., or from 245° C. to 290° C., or from 248° C. to 280° C., or from 250° C. to 275° C., or from 255° C. to 270° C. As in the example, a temperature of 260° C. may advantageously be used.

The softening temperature is chosen so that the composition is fluid enough to flow and is able to be extruded from the nozzle. The composition has advantageously a sufficiently stable viscosity over time at the softening temperature during its residence time in the print head so that the part can be accurately printed despite head print speed variations, and so that print head clogging is avoided even after transient cooling/heating stages. A very low crystallization kinetics such as the one of the PEKKs hereinabove described is necessary to keep the viscosity steady, particularly when the softening temperature is chosen around the composition melt temperature Tm or below Tm. In a steady state, the residence time of softened composition in the print head is of several seconds. However, because of transient states in which the print head is heated when starting to print a new part section or in which the print head is cooled after finishing to print a part section, the maximum residence time of the softened composition in the print head may be of dozens of seconds to several minutes. During these periods, there is some risk that the polymer present in the heated zone may crystalize, and thus may not be able to flow at temperatures near or below Tm. To avoid this, active cooling may need to be used on the heated section of the print nozzle so that cooling is sufficiently fast that the polymer in the heated section of the print nozzle does not experience elevated temperatures where crystallization may occur for long enough that the polymer begins to stiffen. In case the print nozzle may not be heated and cooled quickly enough to avoid this crystallization, the nozzle may initially have to be elevated to some temperature at least 20 to 30° C. above the melt temperature until the crystalline polymer is melted, and then reducing to the softening temperature for steady state operation.

In some embodiments, the composition has a viscosity in the range of 200 to 5000 Pa·s⁻¹ at the softening temperature, as measured in a plate-plate rheometer device at a stress frequency of around or less than 5 rad/s, during a time range of more than 30 seconds, preferably during a time range of 2 minutes, most preferably during a time range of more than 5 minutes.

If necessary, the viscosity at the softening temperature may be controlled to some by adding to the PEKK a viscosity-controlling agent. In order to reduce the viscosity at the softening temperature, a plasticizer compatible with PEKK, such as for example diphenylsulfone, 1,3-bis(4-phenoxybenzoyl)benzene or 1,4-bis (4-phenoxybenzoyl)benzene, may be added. These viscosity-controlling agents may be added at levels of about 0.5% to about 15% by weight of the composition.

Advantageously, the print bed may be heated to a temperature:
from about Tg−75° C. to about Tg+5° C.;
preferably from about Tg−50° C. to about Tg;
and even more preferably from about Tg−20° C. to about Tg−5° C.

The build environment may be actively or passively heated. An actively heated build environment has supplemental heating elements and controls beyond the heated bed that control the air temperature inside the build environment.

Advantageously, the build environment may be heated to a temperature up to about Tg.

The process may take place in air, or under an inert gas such as nitrogen, if the printer makes it possible to control the composition of the gas within the build environment.

The process may take place at atmospheric pressure or at pressures below if the printer makes it possible to control the pressure within the build environment.

Process parameters of the 3-D printer may be adjusted to further minimize shrinkage and warping, and to produce 3-D printed parts having optimum strength and elongation. The use of selected process parameters applies to any extrusion/melt 3D printer, and preferably to filament printing (e.g. FFF). FFF is strongly preferred because the polymers residence time in the heated zone is extremely short and with a narrow distribution. In additive manufacturing processes where a single screw extruder is used, the residence time is comparatively long, and there may be a distribution of residence time from very short to very long. Long residence times at the softening temperature may result in crystallization and an increase in viscosity to the point where the polymer must be heated well above Tm for flow to occur.

The print head speed may be between about 6 to about 200 mm/sec.

The thickness of each print layer may be from about 0.10 mm to about 4 mm.

The process may also comprise a post-crystallization step of the printed part in order to increase the crystallinity of the printed part to a desired level by heating it at a temperature over the glass transition temperature of the composition for a certain amount of time. A crystallization process will increase the maximum use temperature of the object as well as improve its resistance to certain chemicals. A post-crystallization process involves a thermal treatment where crystallization occurs at some temperature above Tg but below Tm. Since this temperature is within the softening window, the thermal treatment may take place with the part supported by an inert, thermally stable media such as glass beads or sand. This support media will maintain the shape of the part as it transitions from a softened amorphous state to a stiffer semicrystalline state.

An advantage of the present invention is the ability to print dimensionally stable (low warping) items using PEKK-based compositions having a low melting point and slow crystallization kinetics. Because of the slow crystallization kinetics, items may be printed at a temperature below the melting point of the composition and may be naturally less prone to warping issues. The slow crystallization kinetics also avoid any clogging issue of the print head. In addition, because of the low printing temperature, the object does not have risk to suffer from high-temperature degradation.

### Example

A PEKK homopolymer consisting of the isophthalic repeat unit was made as follows:

Ortho-dichlorobenzene and 1,3 bis(4-phenoxybenzoyl)benzene were placed in a 2 L reactor with stirring and a stream of nitrogen. A mixture of isophthaloyl chloride and benzoyl chloride was then added to the reactor. The reactor was cooled to: −5° C. Aluminum trichloride was added while maintaining the temperature in the reactor below +5° C. After a homogenization period of about 10 minutes, the reactor temperature was increased by 5° C. per minute until reaching a temperature of 90° C. (it is considered that the polymerization begins during the increase of temperature). The reactor was kept at 90° C. for 30 minutes then cooled to 30° C. A solution of concentrated hydrochloric acid (3.3% by weight HCl) was then added slowly so that the temperature in the reactor did not exceed 90° C. The reactor was stirred for 2 hours then cooled to 30° C.

The PEKK was separated from the liquid effluents and then washed in the presence or absence of acid using standard separation/washing techniques well known to those skilled in the art in order to obtain a “purified wet PEKK”. The purified wet PEKK was dried at 190° C. under vacuum (30 mbar) for 48 hours. Polymer scales, or “flakes”, were obtained.

The polymer flakes have a melting point of about 280° C. as verified by DSC analysis. In addition, when the DSC is carried out on a second heat using a heating rate of 20° C./min the material does not show any crystallization or melting peak.

The flakes have an intrinsic viscosity of 0.7 dl/g as measured at 25° C. in an aqueous solution of sulfuric acid at 96% by mass according to ISO 307: 2019.

The flakes were converted to granules using a twin screw extrusion temperature and strand pelletization. At steady state, the melt temperature was measured by direct insertion of a thermocouple into the molten stream was 330-350° C. The thermoplastic granules obtained by this process were pseudo-amorphous, transparent amber colored. They have no first heat melting point as measured by DSC with a heating rate of 20° C./min.

The pseudo-amorphous pellets were dried to remove excess moisture and then converted to 1.75 mm diameter filament using a Filabot EX6 16 mm single screw extruder using a maximum barrel temperature of 320° C. The filament was air cooled and spooled onto standard fused filament fabrication material spools.

Test specimens were printed by using the manufactured filament of PEKK homopolymer. A LulzBot TAZ Pro printer (Fargo Additive Manufacturing Equipment 3D, LLC) equipped with a 0.4 mm E3D v6 heated nozzle assembly was used. The nozzle assembly temperature was set to 260° C., the print speed was of 30 mm/sec, the print bed temperature was set to 100° C. and the build environment was not enclosed and not heated actively.

A clean nozzle was used before starting a print, and the filament was only introduced to the heated section of the nozzle assembly as printing started. When printing stopped or paused, the filament was retracted from the heated section of the nozzle assembly.

The printed objects were amorphous, as indicated by their clear amber color. The printed objects were post-crystalized by supporting them in quartz sand and heating to 240° C. for 3 hours before slowly cooling. After the post-treatment the objects were semicrystalline, as indicated by their opaque cream color and a crystalline melting point on the first heat DSC with a heating rate of 20° C./min.

### Time Dependent Parallel Plate Rheology

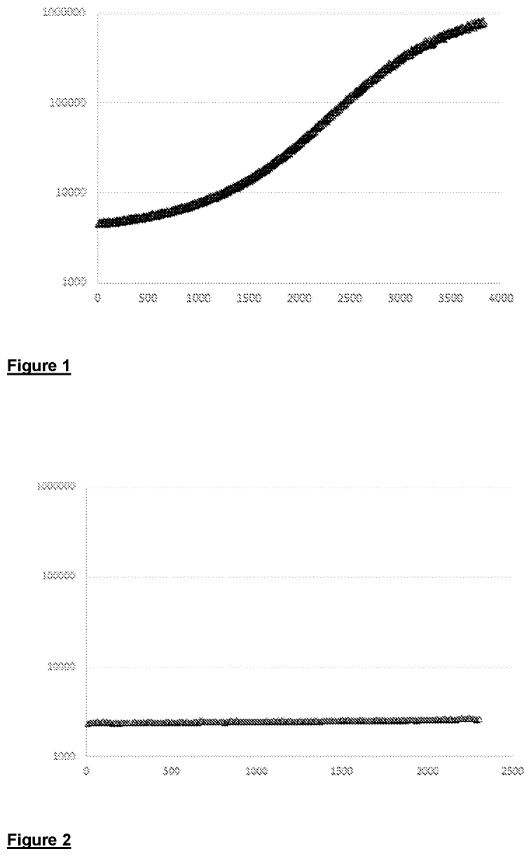

The polymer from the above example was compression molded into a plaque approximately 25 mm in diameter at a temperature of 320° C. The plaques were cooled quickly from their amorphous state and were a transparent amber solid. Time dependent sweeps were generated at 4.9 rad/s and temperatures of 250° C. (see FIG. 1) and 260° C. (see FIG. 2) using an ARES-G2 rheometer with 25 mm parallel plates in a nitrogen atmosphere. The strain amplitudes was 0.03% within the linear viscoelastic region. The samples were placed in a room temperature instrument, and the sample was heated to the test temperature as quickly as the instrument could heat, at approximately 75° C./min.

At 250° C. the material began as a viscous melt with a complex viscosity of about 4500 Pa·s (see FIG. 1). The viscosity increased up to 5000 Pa·s after 307 seconds (more than 5 minutes). After about 2000 seconds, the material became more solid. This transition is likely due to crystallization as the plaque transformed into an opaque solid after the test.

At 260° C. the material remained a viscous melt with a complex viscosity of about 2400 Pa·s for at least 2000 seconds (see FIG. 2).

It can, therefore, be concluded that there exists a temperature window from around 250° C. or above and around Tm or below, notably at or around 260° C., wherein crystallization is sufficiently slow and the complex viscosity is sufficiently low, so that some melt processing of PEKK homopolymer consisting of the isophthalic repeat unit is possible.

1. An additive manufacturing process by extrusion for forming a three-dimensional part with an additive manufacturing machine comprising a nozzle, the process comprising:
i) providing a pseudo-amorphous composition having a glass temperature Tg;
ii) softening the composition at a softening temperature above Tg and below 300° C. to form a softened composition which is fluid enough to flow and, extruding the softened composition from the nozzle to form an extruded part section; and,
iii) solidifying the extruded part section;
wherein the composition is based on a homopolymer or a copolymer of poly-ether-ketone-ketone, essentially consisting of: at least an isophthalic (I) repeating unit, having the formula: 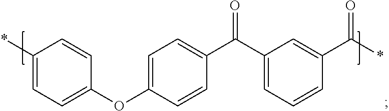
and, in the case of the copolymer, a terephthalic (T) repeating unit, having the formula: 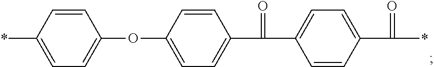
wherein the molar proportion of T units relative to the sum of the T and I units ranges from 0% to 45% or from 55% to 65%.

2. The additive manufacturing process of claim 1, wherein the molar proportion of T units relative to the sum of the T and I units of the poly-ether-ketone-ketone of the composition is equal to or less than 15%.

3. The additive manufacturing process of claim 1, wherein the poly-ether-ketone-ketone of the composition consists essentially of the isophthalic (I) repeating unit.

4. The additive manufacturing process of claim 1, wherein the composition has an inherent viscosity, as measured according to ISO 307 in an aqueous solution of 96% by weight sulfuric acid at 25° C., from about 0.10 dL/g to about 0.90 dL/g.

5. The additive manufacturing process of claim 1, wherein the poly-ether-ketone-ketone of the composition is obtainable by the reaction of 1,3-bis(4-phenoxybenzoyl)benzene and/or 1,4-bis(4-phenoxybenzoyl)benzene with isophthaloyl chloride and/or terephthaloyl chloride.

6. The additive manufacturing process of claim 1, wherein the composition has a viscosity at the softening temperature, as measured in a plate-plate rheometer device at a stress frequency of around or less than 5 rad/s, in the range of 200 to 5000 Pa·s⁻¹ during a time range of more than 30 seconds.

7. The additive manufacturing process of claim 1, wherein the softening temperature is less than Tm+5° C.; and/or
the softening temperature is greater than Tg+50° C.

8. Filament made of a composition of claim 1.

9. Use of a composition according to claim 1 in an additive manufacturing process by extrusion.

10. Object obtained by the process according to claim 1.
